(19) United States
(12) Patent Application Publication
(10) Pub. No.: US 2014/0265103 A1
(43) Pub. Date: Sep. 18, 2014

(54) MEDICAL PRINTER

(71) Applicant: Sony Corporation, Tokyo (JP)

(72) Inventors: Masakazu Sone, Kanagawa (JP); Hideo Nakamura, Kanagawa (JP)

(73) Assignee: Sony Corporation, Tokyo (JP)

(21) Appl. No.: 14/200,766

(22) Filed: Mar. 7, 2014

(30) Foreign Application Priority Data
Mar. 14, 2013 (JP) 2013-051445

(51) Int. Cl. B41J 11/70

(52) U.S. Cl. CPC B41J 11/70
USPC 270/5.02

(57) ABSTRACT

There is provided a medical printer including a main body that accommodates a roll sheet, a movable section capable of being opened and closed with respect to the main body, a first cutting section in the main body, the first cutting section being configured to cut the roll sheet ejected from an ejection port, the ejection port being formed by the main body and the movable section, and a second cutting section on the movable section, the second cutting section being configured to cut the roll sheet ejected from the ejection port. The second cutting section includes a cutter blade at at least one of two ends of the ejection port in a width direction.

### CROSS REFERENCE TO RELATED APPLICATIONS

This application claims the benefit of Japanese Priority Patent Application JP 2013-051445 filed Mar. 14, 2013, the entire contents of which are incorporated herein by reference.

### BACKGROUND

The present disclosure relates to a medical printer that prints on a roll sheet.

Printers are requested to have the performance and usability according to where and how the printers are used. It is also necessary for printers for medical use to have different performance and usability in accordance with situations such as medical care, examination, and other medical matters in which the printers are used. Speaking of performance, printers that print, for example, medical records have to have high-performance of printing fast. Printers for echography have to have such image quality that no light and shade are produced from rough surfaces of printing sheets and irregularity particular to the machines because the printers that print images resulting from echography allow states of affected areas and unborn children to be expressed in light and dark colors for diagnosis. Meanwhile, speaking of usability, printers have to be easily operated and space-saving, which namely means that the printers are not particular about where to be disposed upon use.

For example, a printer mounted and used on a cart 10 as illustrated in FIG. 9 together with a medical examination apparatus 15, a keyboard 16, and a display 17 is suitable as a printer that prints on a roll sheet that is a rolled long sheet, the cart 10 being can be moved by wheels 12 under a base 11. Printers that print on a roll sheet can cut the sheet in accordance with a quantity of print. Moreover, such printers can efficiently accommodate a sheet, thereby being easy to downsize.

Printers that print on a roll sheet have to cut a part of the roll sheet on which the printers have already printed as the printers are outputting the roll sheet. If printers are equipped with an automatic cutting mechanism for automatically cutting a roll sheet, the printers become larger and cost more. Accordingly, there are also a large number of printers that adopt a manual cutting mechanism that allows users to cut a roll sheet by pulling the roll sheet in contact with a cutter blade. For example, JP 2011-37064A and JP H08-34553A disclose printers equipped with a manual cutting mechanism. The manual cutting mechanisms disclosed in JP 2011-37064A and JP H08-34553A each allow users to grasp a roll sheet ejected from the printer, turn up the roll sheet in the opposite direction to the ejecting direction, and pull the roll sheet in contact with the cutter blade in order to make a crack on the roll sheet and cut the roll sheet.

### SUMMARY

However, the printers disclosed in JP 2011-37064A and JP H08-34553A have a limited direction in which a roll sheet is pulled when the roll sheet is cut. Moreover, the printers are disposed in a limited place. Since small printers have no clearance for pulling down a roll sheet, a manual cutting mechanism is usually attached to the conveyance passage of a roll sheet such that the roll sheet is pulled up to be cut. However, supposing, for example, that a printer 18 is mounted on the cart 10 as illustrated in FIG. 9, the printer 18 can be disposed only on a shelf 14b or 14c under a table 14a on which the keyboard 16 is mounted in the example of FIG. 9. For example, when the printer 18 is disposed on the shelf 14b, no clearance for pulling a roll sheet can be provided above the manual cutting mechanism so that it becomes difficult to cut the roll sheet.

It is also conceivable that a manual cutting mechanism is additionally attached to a lower surface of conveyance passage of a printer such that a roll sheet can be pulled down to be cut. However, the roll sheet ejection port is generally a movable section that is opened and closed such that the printer accommodates a roll sheet. There is no providing a cutter blade to the movable section for structural safety reasons.

The present disclosure therefore proposes a novel and improved medical printer that can cut a roll sheet by pulling the roll sheet up or down.

According to an embodiment of the present disclosure, there is provided a medical printer including a main body that accommodates a roll sheet, a movable section capable of being opened and closed with respect to the main body, a first cutting section in the main body, the first cutting section being configured to cut the roll sheet ejected from an ejection port, the ejection port being formed by the main body and the movable section, and a second cutting section on the movable section, the second cutting section being configured to cut the roll sheet ejected from the ejection port. The second cutting section includes a cutter blade at at least one of two two ends of the ejection port in a width direction.

According to another embodiment of the present disclosure, a first cutting section is attached to a main body, which forms an ejection port, while a second cutting section is attached to a movable section. If a roll sheet ejected from the ejection port is pulled toward the first cutting section, the roll sheet can be cut by the first cutting section. Meanwhile, if the roll sheet is pulled toward the second cutting section, the roll sheet can be cut by the second cutting section. Since the second cutting section is attached to the movable section, safety is also ensured by attaching a cutter blade only to an end of the ejection port in a width direction, which a user does not easily touch.

According to one or more of embodiments of the present disclosure, a roll sheet can be cut by being pulled up or down.

### BRIEF DESCRIPTION OF THE DRAWINGS

FIG. 1 is an overall perspective view illustrating a medical printer according to an embodiment of the present disclosure;

FIG. 2 is an overall perspective view with a movable section of the medical printer according to the embodiment opened;

FIG. 3 is an anterior view of the movable section;

FIG. 4 is a posterior view of the movable section;

FIG. 5 is a top view of the movable section;

FIG. 6 is a partial cross-sectional view illustrating an A-A cross section shown in FIG. 3;

FIG. 7 is a partial cross-sectional view of a printer for describing a method for cutting a roll sheet, the method being performed by a first cutting section;

FIG. 8 is a partial cross-sectional view of a printer for describing a method for cutting a roll sheet, the method being performed by a second cutting section; and

FIG. 9 is a perspective view for describing a disposition example of a printer mounted on a cart.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

### 1. Overall Structure

### 2. Manual Cutting Mechanisms

2-1. First Cutting Section

2-2. Second Cutting Section
2-2-1. Cutter Blades
2-2-2. Rib

2-3. Roll Sheet Cutting

### <1. Overall Structure>

First of all, with reference to FIGS. 1 and 2, a schematic structure of a medical printer 100 according to an embodiment of the present disclosure will be described. FIG. 1 is an overall perspective view of the medical printer 100 according to the present embodiment. FIG. 2 is an overall perspective view that illustrates the medical printer 100 according to the present embodiment with a movable section 104 opened. The medical printer 100 will also be simply referred to as a printer 100 below.

The medical printer 100 according to the present embodiment is, for example, a thermal printer that prints images on a roll sheet, the images being generated on the basis of reception signals from a probe that is provided to an ultrasonic diagnostic apparatus and is a medical examination device configured to generate and transmit ultrasound and receive ultrasound reflected in a living body. The present technology can be applied to not only the medical printer 100, but also any printer including a manual cutting mechanism that allows users to cut a roll The medical printer 100 is considered to be mounted and used on the cart 10 as illustrated in FIG. 9 like the printer 18.

The medical printer 100 according to the present embodiment is considered to be a thermal printer, but an embodiment of the present disclosure is not limited to this example. For example, the medical printer 100 may also be an inkjet printer. In this way, the present technology is applicable regardless of printer's printing type. Accordingly, the description about a printing function of the printer being omitted, a main body 102 of the printer 100 includes a print unit that prints on a roll sheet P. A material or a thickness of the roll sheet P is not particularly limited. For example, a thermal film having a thickness of approximately 100 μm may be used for the roll sheet P.

The medical printer 100 according to the present embodiment is, for example, a thermal printer that prints on the roll sheet P. As illustrated in FIG. 1, a housing of the medical printer 100 includes the main body 102 and the movable section 104, the movable section 104 being provided such that the movable section 104 can be opened and closed with respect to the main body 102.

The main body 102 is a case that accommodates a print unit (not shown), which prints on the roll sheet P. An accommodation section 150, which accommodates the roll sheet P, is disposed at a surface (which will be referred to as a “main-body front surface,” below) 102a in the x axis positive direction of the main body 102, as illustrated in FIG. 2. The movable section 104 at the main-body front surface 102a is opened so that the roll sheet P can be accommodated in the accommodation section 150. The main-body front surface 102a is also provided with an operation display section 140 including a power switch, an open button for opening the movable section 104, and a lamp indicating an activity state of the printer 100. The movable section 104 and the operation display section 140 are disposed altogether at the main-body front surface 102a, which allows the printer 100 to be operated if nothing is placed in front of the main-body front surface 102a of the printer 100.

The movable section 104 is a cover member at the main-body front surface 102a such that the movable section 104 can be opened and closed with respect to the main body 102, the movable section 104 being disposed over the accommodation section 150 for the roll sheet P in the main body 102. The movable section 104 includes, for example, a bearing (not shown) that rotatably supports a shaft (not shown) provided on the bottom surface of the printer 100 and extending in the width direction (y direction). The bearing of the movable section 104 rotatably supports the shaft of the main body 102, and a hinge is consequently formed. As illustrated in FIG. 2, the upper portion of the main-body front surface 102a of the movable section 104 can be structured to move with respect to the main body 102.

A part of an upper end 104b of the movable section 104 is recessed in the height direction (z direction), thereby forming a recess 104d. The recess 104d makes a slight gap between the upper end 104b of the movable section 104 and a lower end 102b of the main-body front surface 102a, the lower end 102b facing the upper end 104b. The gap functions as an ejection port 110, from which the roll sheet P is conveyed along the conveyance passage inside the printer 100 to be ejected. The ejection port 110 includes a manual cutting mechanism for cutting the ejected roll sheet P.

After the print unit prints on the roll sheet P accommodated in the accommodation section 150, the roll sheet P is conveyed along the conveyance passage inside the printer 100 and ejected from the ejection port 110. A conveyor roller 160, which conveys the roll sheet P to the ejection port 110, is provided in front of the ejection port 110, as illustrated in FIG. 2.

### <2. Manual Cutting Mechanisms>

The printer 100 according to the present embodiment includes a first cutting section 120 at the lower end 102b of the main-body front surface 102a, and a second cutting section 130 at the recess 104d of the upper end 104b of the movable section 104 as manual cutting mechanisms. Next, with reference to FIGS. 3 to 7, manual cutting mechanisms attached to the medical printer 100 according to the present embodiment will be described.

### [2-1. First Cutting Section]

The first cutting section 120 is a manual cutting mechanism used when the roll sheet P ejected from the ejection port 110 is pulled up to be cut. The first cutting section 120 includes a cutter blade extending in the width direction (y direction) of the ejection port 110. The cutter blade can be made of metal or resin such as plastic. A portion contacted with the roll sheet P is formed in a zigzag or a sharp shape as illustrated in FIG. 1 because it is easier to make a crack in the roll sheet P.

### [2-2. Second Cutting Section]

The second cutting section 130 is a manual cutting mechanism used when the ejected roll sheet P is pulled down to be cut. FIGS. 3 to 6 each illustrate the movable section 104 including the second cutting section 130. FIG. 3 is an anterior view of the movable section 104. FIG. 4 is a posterior view of the movable section 104. FIG. 5 is a top view of the movable section 104. FIG. 6 is a partial cross-sectional view illustrating an A-A cross section shown in FIG. 3.

The second cutting section 130 is provided at the recess 104d of the upper end 104b of the movable section 104. Accordingly, the second cutting section 130 is exposed when the movable section 104 is opened as illustrated in FIG. 2. Thus, the second cutting section 130 according to the present embodiment includes cutter blades 132a and 132b at both the ends of the ejection port 110 in the width direction (y direction), and a rib 134 between the cutter blades 132a and 132b for safety reasons.

### (2-2-1. Cutter Blades)

The cutter blades 132a and 132b of the second cutting section 130 are members for making a crack in the roll sheet P at a cutting position. The cutter blades 132a and 132b are each joined to a joining section 132 at the opposite ends to the cutting edges of the cutter blades 132a and 132b, respectively, thereby being formed as an integrated member, as illustrated in FIG. 4. The joining section 132 is fixed to a rear surface 104c of the movable section 104. The joining section 132 integrates the blade cutters 132a and 132b according to the present embodiment with each other. However, the present technology is not limited to this example. Each of of the cutter blades 132a and 132b may also be fixed to the rear surface 104c of the movable section 104.

Like the first cutting section 120, the cutter blades 132a and 132b can be made of metal or resin such as plastic that has a contact portion with the roll sheet P formed in a zigzag or a sharp shape. The second cutting section 130 is formed at a position where a user can easily touch the second cutting section 130, and requested to be safer than the first cutting section 120. Accordingly, a tip of plastic may be formed in a zigzag as illustrated in FIG. 3, for example.

The cutter blades 132a and 132b, which have very short lengths such as a few mm long, are attached to both the ends of the ejection port 110 in the width direction such that users do not easily touch the cutter blades 132a and 132b. If the cutter blades 132a and 132b are attached both the ends of the ejection port 110 in the width direction, a crack can be made at any ends of the roll sheet P in the width direction. Consequently, users can cut the roll sheet P without paying attention to a cutting direction. The second cutting section 130 of the printer 100 according to the present embodiment includes the cutter blades 132a and 132b at both the ends of the ejection port 110 in the width direction, but the present technology is not limited to this example. A cutter blade may also be attached only to at least any one of the ends of the ejection port 110 in the width direction.

The cutter blade 132a may also be bent as illustrated in FIG. 6, and a cutting edge section 132a1 having the cutting edge may also be inclined in the conveyance direction (x direction) of the roll sheet P. If the cutting edge section 132a1 is substantially vertical to the conveyance direction of the roll sheet P, the roll sheet P comes into contact with the cutter blade 132a inside the main body 102 upon being pulled into the printer 100. As a result, the roll sheet P may not be ejected from the ejection port 110. Accordingly, if the cutting edge section 132a1 of the cutter blade 132a is inclined to a vertical surface (that is, a surface extending in the z direction) of the movable section 104 in the conveyance direction of the roll sheet P, the roll sheet P can be smoothly ejected.

Furthermore, if the cutting edge section 132a1 of the cutter blade 132a is inclined, the second cutting section 130 nearly brings the roll sheet P into point contact with the cutting edge upon cutting the roll sheet P. Accordingly, user's force of pulling the roll sheet P concentrates on this position. Thus, a user can easily make make a crack in the roll sheet P with less force.

An inclination angle (angle formed by the cutting edge section 132a1 and a connection section 132a2 between the cutting edge section 132a1 and the joining section 132) a of the cutter blade 132a can be set, for example, to approximately 90 to 100 degrees. The inclination angle α in this range allows the roll sheet P to be smoothly ejected and a crack to be easily made in the roll sheet P at a cutting position. The cutter blade 132b may also be structured in the same way as the cutter blade 132a.

### (2-2-2. Rib)

The rib 134 of the second cutting section 130 is a member for cutting straight the roll sheet P having a crack in the width direction with any one of the cutter blades 132a and 132b. Thus, the rib 134 does not have to be formed in a zigzag or a sharp shape in order to actively make a crack in the roll sheet P like the cutter blades 132a and 132b. Though the rib 134 is preferably formed in a sharp shape for easily cutting the roll sheet P and making a desired cross section, any material and shape that do not hurt a user when the user touches the rib 134 are adopted for the rib 134 for safety reasons.

A part of the movable section 104 forms the rib 134, as illustrated in FIG. 6. That is, the upper end (which is also referred to as the “tip of the rib 134”) of the recess 104d at the upper end 104b of the movable section 104 extends substantially flush with the cutter blades 132a and 132b in the width direction (y direction) of the ejection port 110 to form the rib 134.

As illustrated in FIG. 3, the rib 134 is formed substantially flush with the cutting edges of the cutter blades 132a and 132b without any steps so that the roll sheet P, which is pulled down, can come into contact with the rib 134 along a crack made by the cutter blade 132a or 132b. As few gaps as possible are made between the rib 134 and each of the cutter blades 132a and 132b such that the cutting edges of the cutter blades 132a and 132b is continuous with the tip of the rib 134. Consequently, a more desired cross section of the roll sheet P can be obtained.

The rib 134 may also be inclined in the conveyance direction of the roll sheet P like the cutter blades 132a and 132b such that it becomes easier to cut the roll sheet P. This is because that if the rib 134 is substantially vertical to the conveyance direction of the roll sheet P, the roll sheet P comes into contact with the rib 134 inside the main body 102 upon being pulled into the printer 100 and the roll sheet P may not be ejected from the ejection port 110. For example, as illustrated in FIG. 6, a top surface (which is also referred to as a “rib top surface”) 134a of the rib 134 is inclined in the conveyance direction of the roll sheet P. An inclination angle (angle formed by the rib top surface 134a and a vertical surface 134b) β of the rib 134 can be set, for example, to approximately 45 to 90 degrees. The inclination angle β in this range allows the roll sheet P to be smoothly ejected.

A front surface 104a of the recess 104d, at which the rib 134 is formed, may also be inclined toward the rear surface 104c, as illustrated in FIG. 6. If the lower portion of the front surface of the rib 134 is scraped in this way, the roll sheet P nearly comes into point contact with the tip of the rib 134 upon being cut by the rib 134. A user can therefore concentrate force of pulling the roll sheet P on this position. Consequently, a user can easily cut the roll sheet P with less force.

When the movable section 104 is closed as illustrated in FIG. 1, the cutter blades 132a and 132b and the rib 134 included in the second cutting section 130 are disposed more deeply in the printer 100 than the front surface 104a of the movable section 104, from which the roll sheet P is ejected. Disposing the second cutting section 130 deep inside the printer 100 prevents the cutting edge from exposure, thereby enhancing safety. As described above, if the lower portion of the rib 134 is scraped, the front surface 104a of the movable section 104 can be inclined. Accordingly, the roll sheet P can be pulled down more when the second cutting section 130 cuts the roll sheet P.

The second cutting section 130 of the printer 100 according to the present embodiment includes the rib 134, but the present technology is not limited to this example. The second cutting section 130 may also include a cutter blade at at least any one of the two ends of the ejection port 110 in the width direction. Once a crack is made in one end of the roll sheet P by a cutter blade, the roll sheet P can also be torn and cut from the starting point crack.

### [2-3. Roll Sheet Cutting]

FIGS. 7 and 8 illustrate methods for cutting the roll sheet P, the methods being performed by the first cutting section 120 and the second cutting section 130, which are manual cutting mechanisms of the medical printer 100 according to the present embodiment. FIG. 7 is a partial cross-sectional view of the printer 100 for describing the method for cutting the roll sheet P, the method being performed by the first cutting section 120. FIG. 8 is a partial cross-sectional view of the printer 100 for describing the method for cutting the roll sheet P, the method being performed by the second cutting section 130.

FIGS. 7 and 8 illustrate conditions of the roll sheet P, which is conveyed along the conveyance passage inside the printer 100 after the print unit prints on the roll sheet P accommodated in the accommodation unit 150. The roll sheet P conveyed from the print unit passes through between the conveyance roller 160 and a guide member 170 so that conveyance speed and a conveyance quantity of the roll sheet P are adjusted. The printed portion alone is ejected from the ejection port 110.

First of all, as illustrated in FIG. 7, the roll sheet P ejected from the ejection port 110 is pulled up, and the first cutting section 120 cuts the roll sheet P. When a user grasps the roll sheet P and pulled it up (z axis positive direction), the roll sheet P comes into contact with the tip of the first cutting section 120 at a cutting position. When the user further pulls up one of the ends of the roll sheet P in the width direction, the first cutting section 120 makes a crack in the roll sheet P at the end. When the user positions the cracked portion at the cutting edge of the first cutting section 120 and pulls up the roll sheet P toward the other end, the roll sheet P continuously has cracks and is finally cut away. Since the whole of the first cutting section 120 is made of a cutter blade, the roll sheet P can be easily cut and a desired cross section can be obtained.

Meanwhile, as illustrated in FIG. 8, the roll sheet P ejected from the ejection port 110 is pulled down, and the second cutting section 130 cuts the roll sheet P. When a user grasps the roll sheet P and pulls it down (z axis negative direction), the roll sheet P comes into contact with the cutting edges of the cutter blades 132a and 132b of the second cutting section 130 at a cutting position. When the user further pulls down one of the ends of the roll sheet P in the width direction, the second cutting section 130 makes a crack in the roll sheet P at the end. For example, when the end of the roll sheet P in the y axis negative direction is pulled down, the roll sheet P comes into contact with the cutter blade 132a and a crack is made at the end.

When the cracked portion is positioned on the cutting edge of the cutter blade 132a, and the roll sheet P is pulled down toward the other end, cracks are further made in the roll sheet P from the cracked portion. The second cutting section 130 includes the cutter blades 132a and 132b only at both the ends. However, since the rib 134 is continuously provided between the cutter blades 132a and 132b, the roll sheet P continuously has cracks along the tip of the rib 134 and is cut. Since the roll sheet P is cut along the rib 134, the roll sheet P can be cut straight without any distortion.

If a part under the portion of the front surface 104a of the movable section 104, at which the rib 134 is formed, is scraped as illustrated in FIG. 8, the roll sheet P can be pulled down more with the second cutting section 130 in contact with the roll sheet 100 when the second cutting section 130 cuts the roll sheet 100. Accordingly, more force of pulling the roll sheet P concentrates on the contact portion of the second cutting section 130 and the roll sheet P, thereby allowing the roll sheet P to be easily cut.

As described above, since the medical printer 100 according to the present embodiment includes manual cutting mechanisms for cutting the roll sheet P at the upper and lower portions of the ejection port 110, from which the roll sheet P is ejected, the roll sheet P can be pulled up or down to be cut. Thus, for example, when the printer 100 is positioned on any one of the shelves 14b and 14c of the cart 10 as illustrated in FIG. 9, it is possible to pull and cut the roll sheet P in a direction in which a clearance is provided.

It should be understood by those skilled in the art that various modifications, combinations, sub-combinations and alterations may occur depending on design requirements and other factors insofar as they are within the scope of the appended claims or the equivalents thereof.

For example, the whole of the first cutting section 120 is made of a cutter blade in the above-described embodiment. However, the present technology is not limited to this example. For example, like the second cutting section 130, the first cutting section 120 may also be structured to include a cutter blade only at at least any one of the ends of the ejection port 110 in the width direction, and provide the other portions with a rib substantially flush with the cutter blade.

The rib 134 of the second cutting section 130 is formed as a part of the movable section 104 in the above-described embodiment. However, the present technology is not limited to this example. For example, like the cutter blades 132a and 132b, a rib may also be formed as a part separate from the movable section 104, and the rib may be fixed to the movable section 104 such that the tip of the rib extends substantially flush with the cutting edges of the cutter blades 132a and 132b in the width direction of the ejection port 110.

Additionally, the present technology may also be configured as below.

(1) A medical printer including:

a main body that accommodates a roll sheet;

a movable section capable of being opened and closed with respect to the main body;

a first cutting section in the main body, the first cutting section being configured to cut the roll sheet ejected from an ejection port, the ejection port being formed by the main body and the movable section; and

a second cutting section on the movable section, the second cutting section being configured to cut the roll sheet ejected from the ejection port,

wherein the second cutting section includes a cutter blade at at least one of two ends of the ejection port in a width direction.

(2) The medical printer according to (1),
wherein the second cutting section further includes a rib having a tip substantially flush with a cutting edge of the cutter blade and extending in a width direction of the ejection port.
   (3) The medical printer according to (2),
wherein the rib is inclined in a conveyance direction of the roll sheet with respect to a vertical surface of the movable section.
   (4) The medical printer according to any one of (1) to (3),
wherein the cutter blade is inclined in a conveyance direction of the roll sheet with respect to a vertical surface of the movable section.
   (5) The medical printer according to any one of (1) to (4),
wherein the second cutting section is disposed more deeply in the medical printer than a surface of the movable section from which the roll sheet is ejected.
   (6) The medical printer according to any one of (1) to (5),
wherein the first cutting section is made of a cutter blade extending in a width direction of the ejection port.

What is claimed is:

1. A medical printer comprising:
a main body that accommodates a roll sheet;
a movable section capable of being opened and closed with respect to the main body;
a first cutting section in the main body, the first cutting section being configured to cut the roll sheet ejected from an ejection port, the ejection port being formed by the main body and the movable section; and
a second cutting section on the movable section, the second cutting section being configured to cut the roll sheet ejected from the ejection port,
wherein the second cutting section includes a cutter blade at at least one of two ends of the ejection port in a width direction.

2. The medical printer according to claim 1,
wherein the second cutting section further includes a rib having a tip substantially flush with a cutting edge of the cutter blade and extending in a width direction of the ejection port.

3. The medical printer according to claim 2,
wherein the rib is inclined in a conveyance direction of the roll sheet with respect to a vertical surface of the movable section.

4. The medical printer according to claim 1,
wherein the cutter blade is inclined in a conveyance direction of the roll sheet with respect to a vertical surface of the movable section.

5. The medical printer according to claim 1,
wherein the second cutting section is disposed more deeply in the medical printer than a surface of the movable section from which the roll sheet is ejected.

6. The medical printer according to claim 1,
wherein the first cutting section is made of a cutter blade extending in a width direction of the ejection port.
